(19) United States
(12) Patent Application Publication
(10) Pub. No.: US 2023/0110658 A1
(43) Pub. Date: Apr. 13, 2023

(54) METHOD FOR MANUFACTURING RAPIDLY AGED SPIRITS

(71) Applicants: Tyler T D'Spain, Madison, WI (US); Sean Callan, Denver, CO (US); Matt Cechovic, McMinnville, OR (US)

(72) Inventors: Tyler T D'Spain, Madison, WI (US); Sean Callan, Denver, CO (US); Matt Cechovic, McMinnville, OR (US)

(21) Appl. No.: 17/962,259

(22) Filed: Oct. 7, 2022

Related U.S. Application Data
(60) Provisional application No. 63/253,327, filed on Oct. 7, 2021.

(51) Int. Cl. C12G 3/07; C12H 1/18

(52) U.S. Cl. CPC C12G 3/07; C12H 1/18

(57) ABSTRACT

A method for producing a rapidly aged spirit is provided that blends a young spirit with an aged spirit and accelerates the formation of flavor compounds through the addition of heat and oxygen in the presence of wood adjuncts over time. Chemical analysis of selected flavor compounds informs the termination of the aging process and can produce a rapidly aged spirit that presents the flavor characteristics and flavor compounds of a mature barrel aged spirit in significantly less time. Contribution of flavor compounds from barrel aged spirits compliments the oxidation of flavor compounds to more complex or long chain molecules.

### RELATED APPLICATIONS

This application claims the benefit of U.S. Provisional Application No. 63/253,327 filed on Oct. 7, 2021, the disclosure of which is incorporated herein in its entirety.

### BACKGROUND OF THE INVENTION

### Field of Invention

The present inventive concept is directed to a method for rapidly producing distilled spirits that present with characteristics associated with a traditionally matured spirit that is aged for a longer period of time. The method applies heat, oxygen, and charred wood to a blend of spirits to reduce negative characteristics and increase the complex flavor characteristics of a combination of spirits. The present invention includes the use of chemical analysis, including gas chromatography mass spectrometry (GC-MS) to evaluate concentrations oof produced flavor compounds, and minimize costs and treatment time needed to achieve the desired treated spirit characteristics.

### Description of the Related Art

For many premium distilled spirits, barrel aging is used to provide a more flavorful, complex, and smoother drinking spirit. For many spirits, particularly whiskey, the time spent in barrel is often directly correlated to the suggested retail price. For example, the typical age of a premium bourbon whiskey retailing for greater the $50 per liter is six to ten years. Due to the cost of barrel aging, the cost of producing a premium bourbon is considerably higher than the cost of the same distillate aged for less time. The costs of aging are primarily due to the storage and maintenance costs, and the evaporation of spirit from the barrel. The benefits of aging are generally considered to be a smoother drinking experience and greater flavor complexity. While a bourbon aged just one to three years is generally considered to be harsh and tastes strongly of grain, a bourbon aged six years or more is generally smooth and rich with flavors of vanilla, caramel, and unique spicy notes that come from aging in new charred oak barrels. Numerous attempts have been made to shorten the maturing or aging process of distilled spirits in order to save time and money while producing a desirable product.

It is known that oxidation occurs in a spirit aged in a wooden barrel, and it is one of the factors that contributes to the positive attributes of an aged spirit. Wooden barrels are permeable to air, albeit at very slow rates of aspiration. In this way, oxygen makes its way into a barrel to facilitate aging and chemical reactions, but also ethanol escapes from the barrel and is lost. Attempts have been made to react a distillate with wood in a steel container to increase contact between the distillate and the wood while reducing losses due to evaporation. Increased reaction activity was observed as described in U.S. Pat. No. 2,132,435 to Reiman which disclosed the use of heat and wood chips. U.S. Pat. No. 2,653,092 to Reiner discloses floating a barrel of spirits in hot water over several days to remove fusel oil and acetic acid. U.S. Pat. No. 9,637,713 to Davis discloses the use of actinic light to simulate the aging of a distilled spirit in contact with wood under heated conditions. U.S. Application No. 16/612,058 by Pawlak discloses the reflux distillation of an unaged bourbon with wood chips to achieve modified flavor characteristics and simulate barrel aging. Reaction rates can be increased by adding heat and oxygen, varying pressure, mechanical agitation, or other methods of increasing interaction with wood or charred wood.

While some of the prominent oak flavor compounds such as whiskey lactones, vanillin, and furfural are present in the spirit aged in a barrel for one to three weeks, their concentrations don’t reach desired levels under normal aging conditions for several years. Further conversions occurring during barrel aging include oxidation and esterification reactions. Even some of the wood extracted compounds, such as vanillin and syringaldehyde are further converted by prolonged exposure to oxygen, acids, and ethanol. It is likely that the slow process of maturation is largely due to the kinetically unfavorable chemical reactions. Low availability of oxygen may also hinder maturation in wooden barrels.

The harshness of young spirits, and the factors that contribute to it, have been researched for many decades without resulting in a clear answer as to what exactly converts a young harsh spirit into an old and smooth spirit. A few factors are known. The fermentation and wood charring processes release and create significant quantities of carboxylic acids, alcohols, and other harsh flavored compounds. Although the small carboxylic acids produced early in the aging process, such as acetic acid, contribute to the harshness of a young spirit, those same compounds are essential in creating the complex flavors of the matured spirit by participating in essential maturation processes.

Other approaches avoid barrel aging altogether, which under US Law prohibits the use of such method to produce certain spirits such as bourbon. U.S. Pat. Application No. 13/592,317 by Lix discloses a method of varying pressure of a distilled spirit in contact with wood to accelerate the interaction of the distilled spirit with the wood. U.S. Pat. No. 8,889,206 to Lix discloses a method of conditioning a wood stave for use in a vessel to age a distilled spirit. Interaction between the distilled spirit and wood can be accelerated by increased surface area of the wood and varying the temperature or pressure of the vessel. These methods have not produced a flavor profile consistent with a mature aged spirit.

What is needed is an economical method to produce a spirit with the characteristics of a long-aged spirit in wooden barrels that does not require 5, 10, or more years and does not lose the same percentages to evaporation as conventional methods. What is needed is a method combining chemical or analytical techniques to accelerate the aging and maturation process, then determine analytically when the desired product has been created.

### SUMMARY OF THE INVENTION

It is an object of the present invention to provide a method of rapidly aging a distilled spirit in the presence of charred wood to provide the desirable chemical characteristics of a mature aged spirit in a reduced time period with reduced product losses.

The aspect of the invention can be provided by a method of producing a rapidly aged spirit comprising the steps of providing a first spirit liquid; providing a second spirit liquid; providing a third spirit liquid; combining said first spirit liquid, said second spirit liquid, and said third spirit liquid to provide an untreated blended spirit; placing said untreated blended spirit into a reaction vessel; determining the concentration of a first flavor compound in said untreated blended spirit; adding a wood adjunct to said reaction vessel; adding oxygen and heat to said reaction vessel to produce an in-treatment blended spirit; determining the concentration of said first flavor compound in said in-treatment blended spirit over time; and terminating the addition of oxygen and heat when the concentration of said first flavor compound in said in-treatment blended spirit is twice the concentration of said first flavor compound in said untreated blended spirit to produce a treated spirit.

In another embodiment of the invention, these aspects can be provided by a method comprising the steps of aging a first distilled spirit in a wooden barrel for a first time period, aging a second distilled spirit in a wooden barrel for a second, longer time period, combining the two aged spirits to produce a blended spirit, and reacting the blended spirit in the presence of wood or charred wood with the addition of heat and oxygen in a closed vessel for a period of at least 4 weeks.

### DETAILED DESCRIPTION OF THE INVENTION

The process of esterification is one of the most critical reactions for flavor maturation. In general, the shorter chain carboxylic acids have a sour or tart flavor, which turns increasingly waxy as the molecular weight of the compound increases. In the presence of ethanol and an acid, such as acetic acid, a process of esterification occurs slowly, converting the carboxylic acids into ethyl esters. The flavors of ethyl esters containing compounds vary greatly, but common flavors include sweet, fruity, and floral. One example observed in a spirit aging process is the conversion of succinic acid, which tastes very tart, to diethyl succinate, which has an apple-like flavor. This process is accelerated by the addition of heat and oxygen, leading to the desired levels of diethyl succinate in approximately 7 weeks.

Other products currently available in the market using rapid aging techniques exist but fail to produce a product with characteristics consistent with a premium spirit. Benchmark concentrations of desired flavor compounds are presented below. Desirable ranges are presented as minimum and maximum benchmark concentrations and were determined by analysis of premium benchmark spirits. Market available spirits were analyzed to determine the concentration of these desired flavor compounds. Market Spirit 1 is manufactured with the use of light and heat to provide rapid aging. Market Spirit 2 is manufactured with the use of pressure and heat to provide rapid aging. Several benchmark compounds are not present in the rapid aged Market Spirits, shown as “non-detect” (ND), which results in flavors that are inconsistent with the premium benchmark spirits. Seven traditionally aged exemplary spirit products were selected through sensory analysis based on their representation of the desired flavor and aroma of a premium spirit. The seven spirit samples were selected to represent a market competitive set, or Benchmark, of products to determine the desired concentrations for each flavor compound. Commercially available flavor reference standards were used to adequately represent the particular characteristics for the purposes of descriptive sensory techniques, as well as chemical analysis. Table 1 presents data from chemical analysis of the of traditional aged spirits with Benchmark Minimum and Benchmark Maximum concentrations as well as the concentrations present in two rapid aged spirits.

TABLE 1

| Compound | Benchmark Minimum (µg/mL) | Benchmark Maximum (µg/mL) | Market Spirit 1: Rapid Age -Light + Heat (µg/mL) | Market Spirit 2: Rapid Age -Pressure + Heat (µg/mL) |
|---|---|---|---|---|
| Furfural | 16,280.5 | 71,033.7 | 6,363.8 | 6,033.5 |
| Nonanoic acid, ethyl ester | 291.3 | 769.4 | 302.5 | 290.3 |
| 5-methyl-2-Furancarboxaldehyde | 963.0 | 6,659.2.00 | 466.2 | 472.6 |
| 2,4-Decadienal, (E,E)- | 56.5 | 134.1 | 49.4 | 77.3 |
| (E)-β-damascenone | 204.4 | 368.4 | ND | 49.3 |
| cis-Whiskey lactone | 1,295.5 | 2,508.1 | ND | 1,699.8 |
| trans-β-Ionone | 22.2 | 43.5 | ND | 7.4 |
| trans-Whiskey lactone | 11,473.6 | 21,719.1 | 408.9 | 13,511.2 |
| Creosol | 56.5 | 166.2 | 135.4 | ND |
| Eugenol | 422.4 | 1,085.2 | 133.7 | 720.3 |

Flavor reference standards were used to identify the key compounds in the seven traditional spirits used in the Benchmark. The desired flavor compounds were identified with corresponding concentrations by gas chromatography time-of-flight mass spectrometry (GC-MS). The chromatographic separation was performed on an Agilent VF-WAXms column using automatic oven temperature programming. Each compound was identified by a comparison of mass spectra and retention times with the NIST Library and flavor reference standards. Prior to analysis, 1 mL of each spirit product was diluted into 3 mL of aqueous sodium chloride solution and spiked with BHT as an internal standard. The compounds were extracted using solid phase microextraction (SPME) with a Divinylbenzene/Carboxen/Polydimethylsiloxane (DVB/CAR/PDMS) fiber. The quantitative analysis performed on the experimental spirit samples provided a target range for each compound which allowed for the determination of the spirit blend selection, rapid aging process timeline, and oak adjunct selection to specifically match the benchmark.

The present invention provides a method of producing a blended spirit with characteristics associated with a spirit aged or matured for a much longer period. The method of the invention can produce a spirit with characteristics of a six-to-ten-year aged spirit that can be produced with an average spirit age of less than four years. Chemical and sensory analysis was used to select an appropriate blend of young spirits with varying age, while controlling to minimize the addition of five- to twelve-year-old spirits. GC-MS analysis was used to quantitatively determine each of the spirit’s chemical compound concentration ranges which was used to identify the optimal ratio of the young one-to-three-year spirits, and the more mature five-to-twelve-year spirits to produce the characteristics of a traditionally aged spirit.

It has been discovered that a product similar to a traditional premium spirit may be produced by blending spirits aged between one and twelve years to form an untreated blended spirit, and using a combination of heat and dissolved oxygen in the presence of wood staves to speed up the chemical reactions of the aging and maturation process. The suite of chemical reactions that transpire in a wooden barrel provides reaction products that are difficult to produce in an inert reaction vessel or in short periods of time such as days or weeks. The use of wood staves allows for the mixing of wood varieties and levels of char to impart different flavors, such as guaiacol, which were not present at the desired concentrations in the untreated blended spirit. The presence of heat and oxygen helps to speed up the chemical processes related to aging and maturation. The combination of heat, oxygen, and wood staves can be applied to the untreated blended spirit for a period of six to twelve weeks while monitoring the levels of key flavor compounds by GC-MS to determine when the desired flavor has been achieved. Exemplary desired flavor compounds and their concentration ranges are presented in Tables 1 and 3. A complete set of compounds that were quantified in the traditional spirit products of the Benchmark is provided in Table 5.

In Example 1, an untreated blended spirit was created by mixing 50% bourbon aged for two years, 34% bourbon aged three years, and 16% bourbon aged twelve years. Each of the bourbons were aged in new charred oak barrels before being blended. The mash bill breakdown for the untreated blended spirit was 67% Corn, 22% Rye, 6% Wheat, and 5% Malt. The untreated blended bourbon was quantitatively analyzed by GC-MS to determine concentration of target compounds, which were compared to the concentration range in a set of exemplary benchmark bourbons. The Benchmark is composed of seven mass market bourbon whiskeys with suggested retail prices ranging from $35 to $65 per 750 mL bottle with barrel ages ranging from five- to ten-years. The addition of oak barrel characteristics that were found to be lacking in the untreated blended bourbon is achieved by the addition of commercially available charred oak staves. As part of the method of determining the oak adjunct or adjuncts to favorably contribute to the finished product, 20 of the available oak adjuncts were evaluated for flavor, aroma, and tactile impacts by both quantitative and qualitative analysis to establish descriptive sensory characteristics and concentrations of key compounds of interest that under rapid aging conditions would bring the age-blended spirit closer to the chemical representation of a traditionally aged spirit at a molecular level. Chemical contributions from each type of stave were determined by adding each stave separately to a small amount of corn whiskey distillate, which was allowed to extract for a period of six weeks. To evaluate the flavor contributions from each stave, the extract was analyzed by GC-MS to determine the concentration of each desired flavor compound extracted from all 20 oak adjuncts. Out of the 20 commercially available oak adjuncts tested, two were selected to improve the aroma and flavor profile of the untreated blended bourbon. Wood Adjunct 1 utilized in Example 1 was EvOak Rickhouse. Wood Adjunct 2 utilized in Example 2 was Barrel Mill Heavy Toast. The analytical results are presented in Table 2 and the process for Example 2 was identical but for the use of Wood Adjunct 2. These compounds highlight the contribution of flavor compounds from wood adjuncts.

TABLE 2

| Compound | Untreated Blended Bourbon (µg/mL) | Benchmark Average (µg/mL) | Example 1 (µg/mL) | Example 2 (µg/mL) |
|---|---|---|---|---|
| 2,4-Decadienal, (E,E)- | 74.1 | 86.7 | 68.0 | 103.7 |
| (E)-β-damascenone | 95.1 | 257.6 | 57.9 | 82.8 |
| cis-Whiskey lactone | 3498.2 | 4124.3 | 79.6 | ND |
| trans-β-Ionone | 30.6 | 34.2 | ND | 8.8 |
| trans-Whiskey lactone | 22541.6 | 19675.0 | 474.1 | 420.6 |
| 4-Ethyl guaiacol | 326.5 | 71.0 | 29.8 | 32.0 |
| Eugenol | 875.1 | 1093.8 | ND | ND |
| Phenol, 4-ethyl- | 27.5 | 43.6 | ND | 17.4 |
| Guaiacol | 217.6 | 352.2 | 104.7 | 101.9 |

Oxygen was also added to the untreated blended spirit using a single channel micro-oxygenation system at a rate of 10 mg/L/month to accelerate oxidation reactions. Samples of the in-treatment blended spirit were analyzed weekly by GC-MS until compounds of furfural, 5-methyl-2-furancarboxaldehyde, guaiacol, and cis-whiskey lactone reached concentrations greater than the minimum benchmark concentrations in Table 1. Once the desired level of each compound was achieved, micro-oxygenation additions were discontinued. The resulting treated spirit was then analyzed again by GC-MS and descriptive sensory analysis methods to ensure the flavor and aroma levels were consistent with the set of benchmark bourbons. Average concentrations of flavor compounds from the benchmark samples were averaged to calculate the Benchmark Average concentrations presented in Table 2. Example 3 was conducted with the use of barrel aged bourbon mixed with raw distilled spirits and placed in a reaction vessel with wood staves for six weeks and kept at 90° F. with the microaddition of oxygen. The product treated spirit (Example 3) was analyzed for the concentration of flavor compounds and compared to the minimum and maximum benchmarks in Table 3.

TABLE 3

| Compound | Benchmark Minimum (µg/mL) | Benchmark Maximum (µg/mL) | Example 3 (µg/mL) |
|---|---|---|---|
| Furfural | 16,280.5.00 | 71,033.7.00 | 24,269.64.00 |
| Nonanoic acid, ethyl ester | 291.3 | 769.4 | 321.99 |
| 2-Furancarboxaldehyde, 5-methyl- | 963.0 | 6,659.2.00 | 1,520.52.00 |
| 2,4-Decadienal, (E,E)- | 56.5 | 134.1 | 98.04 |
| (E)-β-damascenone | 204.4 | 368.4 | 469.24 |
| Guaiacol | 135.8 | 472.6 | 146.41 |
| cis-Whiskey lactone | 1,295.5.00 | 2,508.1.00 | 1,441.21.00 |
| trans-β-Ionone | 22.2 | 43.5 | 27.48 |
| trans-Whiskey lactone | 11,473.6.00 | 21,719.1.00 | 8,920.49.00 |
| Creosol | 56.5 | 166.2 | 120.70 |
| Eugenol | 422.4 | 1,085.2.00 | 567.88 |
| Vanillin | 6,292.7.00 | 20,044.7.00 | 11,929.36.00 |
| γ-Nonalactone | 82.4 | 390.6 | 282.32 |
| γ-Decalactone | 20.5 | 78.7 | 70.55 |
| Benzeneacetic acid, ethyl ester | 166.5 | 471.7 | 186.69 |
| 1-Pentanol | 1,611.0.00 | 6,488.1.00 | 1,579.25.00 |
| 4-Ethyl guaiacol | 41.7 | 130.6 | 163.87 |

The present invention allows for a combination of traditional barrel aging, blending, and rapid aging that achieves both the desired flavor and smoothness of a traditionally aged bourbon as ensured by chemical analysis and category benchmarking. The use of a traditional barrel aged spirit provides a set of chemical compounds that serve as reagents for chemical reactions to occur in the rapidly aged spirits. Where prior rapid aging approaches have not utilized any barrel aged spirits, the present invention provides the complex chemical variety of compounds in a blended spirit to accelerate the formation of compounds previously only found with barrel aged spirits. The selected variously aged spirits used to create the untreated blended spirit blend are analyzed by GC-MS to determine the presence of desired flavor compounds and relative concentrations. Wood adjuncts suitable for the desired flavor profile of the final treated bourbon are also selected based on analytical chemical investigation of the many wood adjunct flavor profiles and compound concentrations. Preferred adjuncts are added to the untreated blended spirit which produces a chemical reaction resulting in the targeted flavor profile of the final treated spirit. The oxygenation of the blended spirit in the presence of the wood adjunct is also monitored with the use of GC-MS analytical methods to determine the appropriate temporal endpoint of additional oxygenation.

Another experiment, example 4, was conducted to determine the contribution of flavor compounds contributed or aided by reactions with charred wood. A first spirit liquid, bourbon aged in charred oak barrel for one year, and a second spirit liquid, bourbon aged in a charred oak barrel for five years, were combined to produce an untreated blended spirit and tested for the presence of selected flavor compounds. Additionally, market spirit 3 and market spirit 4 were tested for the concentration of selected flavor compounds. The results are presented in Table 4. Market spirit 3 in this example was Woodford Reserve Kentucky Straight Bourbon. Market spirit 4 was Elijah Craig Small Batch Kentucky Straight Bourbon. The compounds were selected as representative of the composition of aged spirits that are known to have favorable flavor profiles.

The untreated blended spirit was placed in a stainless-steel reactor vessel and 0.3 mg/l/day of oxygen was added for ten weeks. The temperature was maintained at 90° F. After ten weeks of periodic analysis of the composition of the in-treatment spirit, the addition of heat and oxygen were discontinued and analysis of the selected flavor compounds produced the concentrations listed for Example 4 in Table 4.

TABLE 4

Concentration shown as µg/mL

| Compound | Furfural | 5-methyl-2-Furancarboxaldehyde | 2,4-Decadienal, (E,E)- | (E)-β-damascenone | Guaiacol |
|---|---|---|---|---|---|
| Market Spirit 3 | 30,754 | 2,412 | 64 | 296 | 164 |
| Market Spirit 4 | 33,240 | 1,392 | 82 | 383 | 244 |
| Spirit blend at start | 13,647 | 806 | 91 | 472 | 172 |
| Spirit blend after 10 weeks | 48,029 | 4,595 | 141 | 884 | 313 |
| Increase in concentration | 34,382 | 3,789 | 50 | 412 | 141 |
| Percent increase in concentration | 252% | 470% | 55% | 87% | 82% |

TABLE 4 continued

| Compound | cis-Whiskey lactone | trans-β-Ionone | trans-Whiskey lactone | Eugenol | Vanillin | 4-Ethyl guaiacol |
|---|---|---|---|---|---|---|
| Market Spirit 3 | 1,296 | 28 | 11,040 | 422 | 16,847 | 44 |
| Market Spirit 4 | 2,487 | 39 | 20,825 | 669 | 16,835 | 100 |
| Spirit blend at start | 1,255 | 28 | 8,529 | 606 | 3,373 | 190 |
| Spirit blend after 7 days | 3,044 | 59 | 9,175 | 962 | 5,506 | 284 |
| Increase in concentration | 1,789 | 31 | 646 | 356 | 2,133 | 94 |
| Percent increase in concentration | 143% | 111% | 8% | 59% | 63% | 49% |

The combination of rapid aging techniques, selected addition of wood adjuncts, analytical chemistry, blending of raw distillate or young aged spirits with older aged spirits, and category benchmarking provides a rapidly aged spirit with a desirable traditionally aged flavor profile. The concentration increase of furfural by over 200% improves the sweetness of the treated spirit. Guaiacol is contributed by charred wood components and the measured increase of over 80% adds a smoke characteristic to the treated spirit. Cis-Whiskey lactone is a characteristic whiskey flavor compound and is shown to be increased by greater than 100% over the starting concentration. Trans-β-Ionone can impart a floral characteristic to a spirit and is shown here to have increased by more than 100% during treatment. Trans-Whiskey lactone is a whiskey flavor compound and is shown to be increased by greater than 100% over the starting concentration. 5-methyl-2-Furancarbox-aldehyde provides a complex flavor with a spicy-sweet aspect and caramel smell. The concentration shows more than a 400% increase over the starting concentration or more than five times the starting concentration. The increased concentration of these flavor compounds can be selected as action levels either as compared to their starting concentrations, compared to benchmark minimums, or compared to benchmark averages, to determine that the rapid aging process has produced sufficient amounts of desired flavor compounds. Vanillin is shown in Table 4 as having increased by 63% or more than 50% as measured against its starting concentration.

A method of practicing the invention comprises the steps of providing a first spirit liquid, a second spirit liquid, and optionally a third spirit liquid to create an untreated spirit blend. The first spirit liquid can comprise a young spirit, or one aged in a barrel or oak barrel for six months to a year. The second spirit liquid can comprise a moderate aged spirit or one aged in a barrel for one year to five years. The third spirit liquid can comprise a long-aged spirit or one aged in a barrel for five years to fifteen years. The untreated spirit blend is then analyzed to determine the concentration of a number of flavor compounds. The concentration of these compounds is compared to a benchmark comprising a minimum concentration or an average concentration of the flavor compounds. In an embodiment of the invention, the spirit liquids can comprise Bourbon. The untreated blended spirit is then placed in a reactor vessel with a wood adjunct and heat and oxygen are added over a period of time to increase oxidation and other chemical reactions. The wood adjunct can be selected based on the expected contribution of flavor compounds. Heating and oxygenating in the presence of a wood adjunct provides an in-treatment blended spirit. The in-treatment blended spirit is analyzed for the presence of desired flavor compounds to determine sufficient chemical conversion has been achieved and the rapid aging process has been completed to produce a treated spirit liquid. The invention provides a method of utilizing a combination of traditional barrel aging, blending, and rapid aging that achieves both the desired flavor and smoothness of a traditionally aged spirits such as whisky or bourbon whiskey confirmed by chemical analysis.

Additional compounds were identified as present in spirits that contribute to a flavor profile of a beverage. A list of flavor compounds of distilled spirits or alcoholic beverages as determined by GC-MS is included in Table 5. These compounds may be used in addition to the compounds listed above to determine the progress and sufficiency of rapid aging in producing a desirable product and establish that conversion of the spirit liquids to a treated spirit is complete.

TABLE 5

| | |
|---|---|
| Butanoic acid, ethyl ester | Octanoic acid, 3-methylbutyl ester |
| 1-Propanol | Butanedioic acid, diethyl ester |
| Butanoic acid, 2-methyl-, ethyl ester | 1-Decanol |
| Butanoic acid, 3-methyl-, ethyl ester | Methyl salicylate |
| 1-Propanol, 2-methyl- | Benzeneacetic acid, ethyl ester |
| 1-Butanol, 2-methyl-, acetate | 2,4-Decadienal, (E,E)- |
| 1-Butanol, 3-methyl-, acetate | Acetic acid, 2-phenylethyl ester |
| Pentanoic acid, ethyl ester | (E)-β-damascenone |
| Pentanoic acid, 2-methyl-, ethyl ester | Dodecanoic acid, ethyl ester |
| 2-Heptanone | Geraniol |
| 1-Butanol, 3-methyl- | Guaiacol |
| Hexanoic acid, ethyl ester | cis-Whiskey lactone |
| 1-Pentanol | Phenylethyl Alcohol |
| p-Cymene | trans-β-Ionone |
| Butanoic acid, pentyl ester | trans-Whiskey lactone |
| Heptanoic acid, ethyl ester | Creosol |
| Propanoic acid, 2-hydroxy-, ethyl ester, (L)- | 2-Pentadecanone |
| 1-Hexanol | γ-Nonalactone |
| Octanoic acid, methyl ester | Phenol, 4-ethyl-2-methoxy- |
| Octanoic acid, ethyl ester | Cinnamaldehyde, (E)- |
| Furfural | Octanoic acid |
| Acetic acid | Ethyl cinnamate |
| Benzaldehyde | γ-Decalactone |
| 2-Nonenal, (E)- | Eugenol |
| Nonanoic acid, ethyl ester | Phenol, 4-ethyl- |
| Linalool | n-Decanoic acid |
| 1-Octanol | Benzoic acid |
| 2,6-Nonadienal, (E,E)- | Dodecanoic acid |
| 2-Furancarboxaldehyde, 5-methyl- | Vanillin |
| 2,6-Nonadienal, (E,Z)- | trans-Farnesol |
| Decanoic acid, ethyl ester | 4-Ethyl guaiacol |

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A method of producing a rapidly aged spirit comprising the steps of:
providing a first spirit liquid;
providing a second spirit liquid;
providing a third spirit liquid;
combining said first spirit liquid, said second spirit liquid, and said third spirit liquid to provide an untreated blended spirit;
placing said untreated blended spirit into a reaction vessel;
determining the concentration of a first flavor compound in said untreated blended spirit;
adding a wood adjunct to said reaction vessel;
adding oxygen and heat to said reaction vessel to produce an in-treatment blended spirit;
determining the concentration of said first flavor compound in said in-treatment blended spirit over time; and
terminating the addition of oxygen and heat when the concentration of said first flavor compound in said in-treatment blended spirit is twice the concentration of said first flavor compound in said untreated blended spirit to produce a treated spirit.

2. The method of claim 1 wherein:
said first flavor compound is trans-β-Ionone.

3. The method of claim 1 wherein:
said first spirit liquid is a barrel aged bourbon aged for at least two years;
said second spirit liquid is a barrel aged bourbon aged at least three years;
said third spirit liquid is a barrel aged bourbon aged at least twelve years; and
said first flavor compound it cis-Whiskey lactone.

4. The method of claim 1 further comprising the steps of:
determining the concentration of a second flavor compound in said untreated blended spirit;
determining the concentration of said second flavor compound in said in-treatment blended spirit over time; and
said terminating step is executed when said second flavor compound in said in-treatment blended spirit is at least three times the concentration of said second flavor compound in said untreated blended spirit.

5. The method of claim 1 further comprising the steps of:
determining the concentration of 5-methyl-2-Furancarboxaldehyde in said untreated blended spirit;
determining the concentration of 5-methyl-2-Furancarboxaldehyde in said in-treatment blended spirit over time; and
said terminating step is executed when said 5-methyl-2-Furancarboxaldehyde concentration in said in-treatment blended spirit is at least five times said concentration of 5-methyl-2-Furancarboxaldehyde in said untreated blended spirit.

6. The method of claim 1 further comprising the steps of:
determining the concentration of vanillin in said untreated blended spirit;
determining the concentration of vanillin in said in-treatment blended spirit over time; and
said terminating step is executed when said vanillin in said in-treatment blended spirit is at least 50% greater than said concentration of vanillin in said untreated blended spirit.
